(19) United States
(12) Patent Application Publication
(10) Pub. No.: US 2009/0141756 A1
(43) Pub. Date: Jun. 4, 2009

(54) Adaptive Thermal Feedback System for a Laser Diode

(76) Inventor: Channamallesh G. Hiremath, Plano, TX (US)

Correspondence Address: TEXAS INSTRUMENTS INCORPORATED, P O BOX 655474, M/S 3999, DALLAS, TX, 75265, US

(21) Appl. No.: 11/948,691

(22) Filed: Nov. 30, 2007

(51) Int. Cl. H01S 3/02

(52) U.S. Cl. 372/34

(57) ABSTRACT

According to one embodiment of the disclosure, a thermal feedback system comprises an adaptive controller coupled to a heater element and a temperature sensor. The heater element and the temperature sensor are thermally coupled to a laser diode. The adaptive controller estimates an estimated error according to a measured temperature from the temperature sensor, and determines a target from the estimated error and a temperature reference. The adaptive controller adjusts an input to the transfer function model according to the target to decrease the estimated error. The input to the transfer function model drives the heater element.

### TECHNICAL FIELD OF THE DISCLOSURE

This disclosure generally relates to feedback systems, and more particularly to a thermal feedback system for a laser diode.

### BACKGROUND OF THE DISCLOSURE

A light amplification by simulated emission of radiation (LASER) device generates a coherent light beam. Photons comprising a coherent light beam are generally similar in wavelength and aligned in phase and polarization. A light beam produced by a laser may have relatively low divergence. That is, the beamwidth of the beam does not expand significantly over a long distance.

### SUMMARY OF THE DISCLOSURE

According to one embodiment of the disclosure, a thermal feedback system comprises an adaptive controller coupled to a heater element and a temperature sensor. The heater element and the temperature sensor are thermally coupled to a laser diode. The adaptive controller estimates an estimated error according to a measured temperature from the temperature sensor, and determines a target from the estimated error and a temperature reference. The adaptive controller adjusts an input to the transfer function model according to the target to decrease the estimated error. The input to the transfer function model drives the heater element.

Some embodiments of the disclosure may provide numerous technical advantages. For example, one embodiment of the thermal feedback system may be relatively more predictable than other known thermal feedback systems. The thermal feedback system provides a relatively predictable procedure of calibrating the thermal feedback system for a number of laser diodes incorporating a periodically polled lithium niobate device, which may be relatively sensitive to changes in temperature.

Some embodiments may benefit from some, none, or all of these advantages. Other technical advantages may be readily ascertained by one of ordinary skill in the art.

### BRIEF DESCRIPTION OF THE DRAWINGS

A more complete understanding of embodiments of the disclosure will be apparent from the detailed description taken in conjunction with the accompanying drawings in which:

FIG. 1 is a block diagram showing one embodiment of a thermal feedback system for a laser diode according to the teachings of the present disclosure;

FIG. 2 is a block diagram showing one embodiment of a calibration system that may be used to calibrate the thermal controller of FIG. 1;

FIG. 3 is a block diagram showing one embodiment of an operating configuration of the thermal feedback system of FIG. 1;

FIG. 4 is a flowchart showing one embodiment of a series of actions that may be performed by the thermal controller of FIG. 1; and

FIGS. 5 and 6 show example plots of an estimation error and a deviation error, respectively, of the thermal feedback system of FIG. 1.

### DETAILED DESCRIPTION OF EXAMPLE EMBODIMENTS

As described previously, light beams generated by lasers may comprise photons having a generally similar wavelength. That is, the light beams have a mono-chromatic characteristic. The mono-chromatic characteristic may be modified using various materials, such as periodically poled lithium niobate (PPLN). Periodically polled lithium niobate materials may convert an infrared laser light beam into visible light.

Periodically polled lithium niobate materials have transfer characteristics that are generally dependent on their operating temperature. Accordingly, the operating efficiency of these materials may depend upon the control of their operating temperature.

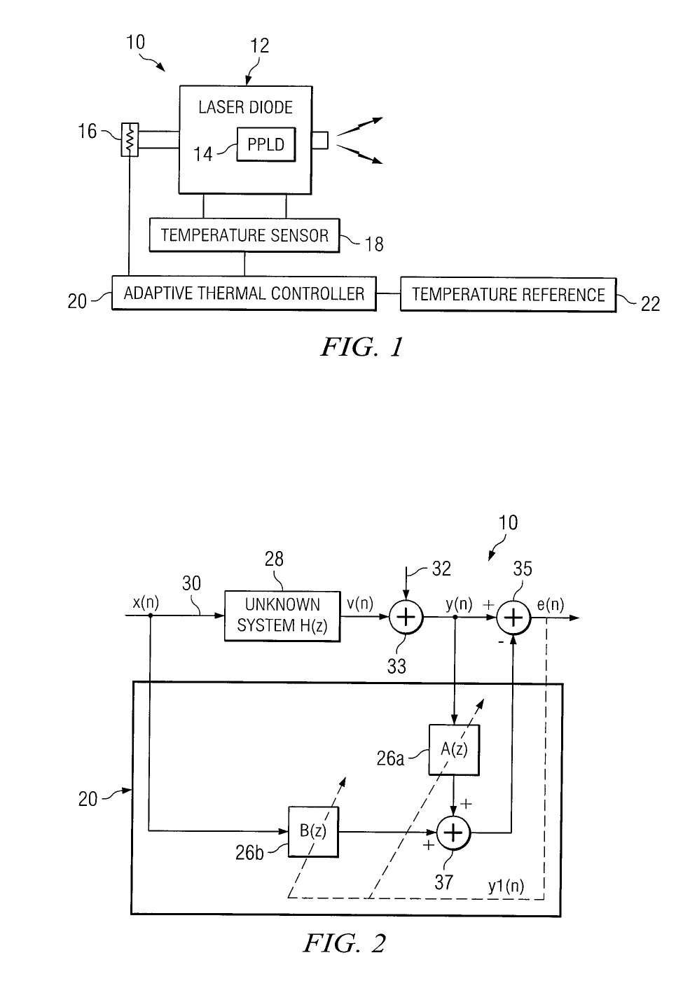

FIG. 1 shows one embodiment of a thermal feedback system 10 that may be used to control the operating temperature of a laser diode 12 incorporating a periodically polled lithium niobate device 14. Thermal feedback system 10 generally includes a heater element 16 and a temperature sensor 18 coupled to an adaptive controller 20. Adaptive controller 20 estimates an estimated error from temperature sensor 18 and a temperature reference 22 and adjusts power to heater element 16 using an adaptive transfer function model. Although this particular embodiment describes thermal feedback system 10 that controls the temperature of a laser diode 12, the temperature of other devices may be controlled by thermal feedback system 10.

Certain embodiments of thermal feedback system 10 incorporating adaptive controller 20 may precisely control the operating temperature. Known thermal feedback systems incorporating proportional-integral-derivative (PID) loops may require tuning to account for variations in operating characteristics of a number of laser diodes manufactured according to a particular process. Thermal feedback system 10, however, incorporates adaptive controller 20 that continually adapts to changes in ambient temperature and operating conditions without tuning prior to use.

Heater element 16 is thermally coupled to laser diode 12 and may be any suitable device that imparts heat to laser diode 12. In one embodiment, heater element 16 is an electrically resistive device that generates heat as a result of electrical current flow. Adaptive controller 20 may adjust power to heater element 16 by controlling electrical current flow through heater element 16.

Temperature sensor 18 may be any suitable device that creates a signal indicative of the operating temperature of laser diode 12. In one embodiment, temperature sensor 18 may be a thermocouple that generates an electrical voltage based upon a temperature gradient across a junction. In another embodiment, temperature sensor 18 may be a resistance temperature detector (RTD). A resistance temperature detector measures temperature by using materials with a resistance that varies predictably in response to changes in temperature.

Laser diode 12 may be any suitable device that uses a semiconductor material to generate a light beam. Laser diode 12 may include a crystalline solid host doped with ions that provide the desired excited energy state transitions. In one embodiment, laser diode 12 incorporates a periodically polled lithium niobate device 14 that converts infrared light into visible light having a relatively higher frequency than infrared light. Periodically polled lithium niobate device 14 converts infrared light into visible light using a nonlinear optical process referred to as frequency doubling.

The transmissivity of periodically polled lithium niobate devices 14 may be temperature dependent. Accordingly, periodically polled lithium niobate device 14 may operate efficiently within a relatively small temperature range. In one embodiment, thermal feedback system 10 may be operable to control the temperature of the laser diode within ±0.1 degree Celsius.

Adaptive controller 20 has a transfer function model. The transfer function model mathematically describes the output of adaptive controller 20 relative to its input. Adaptive controller 20 can adjust its transfer function model according to input/output perturbations in laser diode 12 and/or changes in ambient conditions.

Adaptive controller 20 may be implemented using any suitable logic. In one embodiment, adaptive controller 20 may be implemented on a computing system having a computer processor executing instructions stored in a memory. Adaptive controller 20 may be implemented on a dedicated computing system or on a computing system that performs other functions, such as, for example, other functions that may support operation of laser diode 12.

Modifications, additions, or omissions may be made to thermal feedback system 10 without departing from the scope of the invention. The components of thermal feedback system 10 may be integrated or separated. For example, laser diode 12 may be packaged with an on-board heater element 16 and a temperature sensor 18 or laser diode 12 may be packaged independently of heater element 16 and/or temperature sensor 18. Moreover, the operations of thermal feedback system 10 may be performed by more, fewer, or other components. For example, the operations of adaptive controller 20 may be performed by a dedicated computing system, or the operations of adaptive controller 20 may be performed by a computing system that performs other tasks. Additionally, operations of thermal feedback system 10 may be performed using any suitable logic comprising software, hardware, and/or other logic. As used in this document, “each” refers to each member of a set or each member of a subset of a set.

FIG. 2 shows one embodiment of a calibration system that may be used to calibrate thermal feedback system 10. Thermal feedback system 10 may be calibrated any time prior to operation of laser diode 12 in a normal manner, or during the serviceable life of laser diode 12.

Calibration system includes an unknown system 28 coupled to adaptive controller 20 through summing components 33 and 35. Adaptive controller 20 includes a transfer function model 26 having a finite impulse response portion 26b and an infinite impulse response portion 26a coupled together through a summing component 37. Unknown system 28 may include laser diode 12, heater element 16, and temperature sensor 18 of FIG. 1.

Summing component 33 couples noise source 32 to the unknown system 28. Summing component 33 sums the output of unknown system 28 with noise source 32 to generate output y(n). In one embodiment, summing component 33 comprises an electrical circuit that sums the output of unknown system 28 with noise source 32 as an analog voltage level.

Summing component 37 couples finite impulse response portion 26b to infinite impulse response portion 26a. Summing component 37 sums the output of finite impulse response portion 26b with the output of infinite impulse response portion 26a to generate an output of the adaptive controller 20. Summing component 37 may comprise an electrical circuit or comprise a portion of a computer processing circuit in a manner similar to summing component 33.

Summing component 35 couples output y(n) to the output of adaptive controller 20. Summing component 35 sums the output y(n) with the output of adaptive controller 20 to generate an estimated error e(n). Summing component 35 may comprise an electrical circuit or comprise a portion of a computer processing circuit in a manner similar to summing component 33.

Finite impulse response portion 26b generally responds to instantaneous perturbations on the unknown system 28. Infinite impulse response portion 26a generally has longer response span and models large impulse responses of the unknown system 28. In one embodiment, infinite impulse response portion 26a is implemented as a lattice filter. The lattice filter may maintain the stability of infinite impulse response portion 26a.

Thermal feedback system 10 may be calibrated by adjusting transfer function model 26. In one embodiment, transfer function model 26 may comprise one or more polynomial functions. In one embodiment, transfer function model 26 comprises a fifth order polynomial function. In one embodiment, thermal feedback system 10 may be calibrated by finding the poles and/or zeroes of thermal feedback system 10 and adjusting coefficients of the polynomial function according to the poles and/or zeroes that were found. In another embodiment, transfer function model 26 may be adjusted by modifying the variables or vectors of its one or more polynomial functions. For example, a particular polynomial function may be adjusted by converting it from a fifth order polynomial function to a fourth order polynomial function.

An input signal 30 may be used to calibrate thermal feedback system 10. In one embodiment, input signal 30 may comprise a random signal combined with a direct current (DC) bias. The direct current bias simulates the normal operating temperature of periodically polled lithium niobate device 14, which may be approximately 73 to 105 degrees Celsius. In another embodiment, input signal 30 may be filtered with a low-pass filter to improve the operation of transfer function model 26 at relatively lower frequencies. Input signal 30 may be filtered with a second order low-pass filter having a normalized cutoff frequency of 0.2 with respect to a sampling frequency of transfer function model 26.

In one embodiment, thermal feedback system 10 may be calibrated while no input drive power is applied to laser diode 12 and/or while the ambient temperature is maintained at a relatively constant level. Input drive power generally refers to electrical power applied to laser diode 12 to generate light. Heat may also be generated.

Calibration of thermal feedback system 10 may be modeled by the following formula:

Y(z)=H(z)X(z)+V(z) (1)

where:

z represents the z-transform of a sampled signal with sample index n;

Y(z) represents the unknown system output;

X(z) represents the input of the unknown system;

H(z) represents the unknown system; and

V(z) represents the noise.

The output of the adaptive thermal controller may then be:

Y₁(z)=A(z)Y(z)+B(z)X(z) (2)

where:

A(z) represents the infinite impulse response portion; and

B(z) represents the finite impulse response portion.

The calibration process may be performed by recursively adjusting transfer function model 26 to minimize a mean square error e(n) according to the formula:

e²(n)=(Y(n)−Y₁(n)) (3)

In one embodiment, infinite impulse response portion 26a is calibrated according to a least mean squares (LMS) process. In other embodiments, infinite impulse response portion 26a may be calibrated according to a normalized least mean squares (NLMS) process or a recursive least squares (RLS) process.

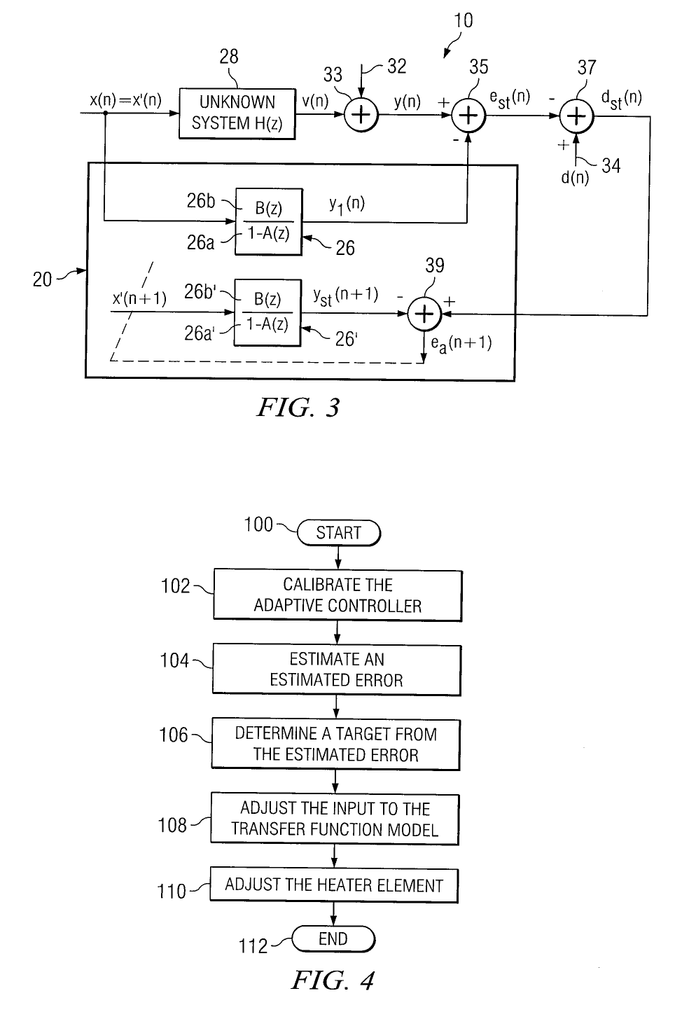

FIG. 3 shows one embodiment of a block diagram of adaptive controller 20 that may be used during operation. A desired input d(n) 34 represents temperature reference 22 of FIG. 1. A summing component 37 sums the desired input d(n) 34 with the estimated error eₛₜ(n) from summing component 35. Adaptive controller 20 is programmed with a transfer function model 26 identified by the calibration process of FIG. 2. Accordingly, transfer function model 26 has a finite impulse response portion 26b and an infinite impulse response portion 26a. Adaptive controller 20 finds input to transfer function model 26′ to minimize the error between dₛₜ(n) and yₛₜ(n+1). Transfer function model 26′ comprises infinite impulse response portion 26a′ and finite impulse response portion 26b′.

Summing component 39 couples the target dₛₜ(n) with the output of transfer function model 26′. Summing component 39 sums target dₛₜ(n) with the output of transfer function model 26′. An input signal that minimizes error eₐ(n+1) at component 39 is found and is used to adjust power to the heater element 16 during the next sample instant.

In one embodiment, adaptive controller 20 performs continuous input power adaptation. Continuous adaptation generally refers to adjusting an input x(n) to transfer function model.

The estimation error eₛₜ(n) is the error between the output y(n) of unknown system 28 and the output y₁(n) of adaptive controller 20. Estimation error eₛₜ(n) may be expressed by the following formula:

eₛₜ(n)=eₘ(n)+eₗ(n)+e_{amb}(n) (4)

where:

eₘ(n) represents the modeling error;

eₗ(n) represents the laser temperature change error; and

e_{amb}(n) represents the ambient temperature change error.

Modeling error eₘ(n) represents an inaccuracy of transfer function model 26. Laser temperature change error eₗ(n) represents an error that may be induced due to inherent heating of laser diode 12. Ambient temperature change error e_{amb}(n) represents an error that may be induced due to changes in ambient temperature.

Estimation error eₛₜ(n) may be summed with reference temperature d(n) to derive a target dₛₜ(n). Target dₛₜ(n) may be used to estimate the next input voltage level x′(n+1) for the transfer function model 26.

In one embodiment, input to controller 20 is adjusted transfer function model 26 by searching for a new input level within a valid range of input levels to find a minimum error between transfer function model output yₛₜ(n+1) and temperature reference output dₛₜ(n).

Adaptive controller 20 uses the next input excitation x′(n+1) to reduce the difference between transfer function model output yₛₜ(n+1) and temperature reference output dₛₜ(n). That is, the next input excitation x′(n+1) is adjusted to decrease the error between output y(n) of unknown system 28 and temperature reference output d(n).

Adaptive controller 20 uses adjusted transfer function model 26′ with the next input excitation x′(n+1) to reduce the difference between transfer function model output yₛₜ(n+1) and temperature reference output dₛₜ(n). That is, adjusted transfer function model 26′ varies its response for the next input excitation x′(n+1) to minimize the error between output y(n) of unknown system 28 and temperature reference output d(n).

Adaptive controller 20 may sample at any suitable sampling rate. In one embodiment, the sampling rate may be chosen such that change in estimation error eₛₜ(n) between consecutive samples is less than half the maximum allowed tolerance of the temperature.

FIG. 4 shows one embodiment of a method that may be performed by adaptive controller 20. In act 100, the process is initiated.

In act 102, adaptive controller 20 is calibrated. Adaptive controller 20 may receive an input signal 30 and recursively adjust its transfer function model 26 in response to this input signal 30 to calibrate adaptive controller 20. The calibration yields a transfer function model 26 with finite impulse response portion 26b and an infinite impulse response portion 26a.

Operation of thermal feedback system 10 continues with reference to acts 104 through 110. That is, the acts 104 through 110 describe actions that may be repeated during operation.

In act 104, the adaptive controller 20 may estimate an estimated error from the measured temperature and transfer function model 26. The measured temperature may be received from temperature sensor 18 thermally coupled to laser diode 12. The estimated error may be estimated by summing the measured temperature with output y₁(n) of adaptive controller 20.

In act 106, adaptive controller 20 may determine a target dₛₜ(n) from estimated error eₛₜ(n) and temperature reference 22. Target dₛₜ(n) may be determined by summing estimated error eₛₜ(n) with desired temperature d(n) from temperature reference 22.

In act 108, adaptive controller 20 may adjust the input to transfer function model 26 that converges the measured temperature with the temperature reference.

In act 110, adaptive controller 20 may adjust power to heater element 16 according to estimated error eₛₜ(n). That is, adaptive controller 20 adjusts power to heater element 16 according to adjusted transfer function model 26. In one embodiment, adaptive controller 20 performs continuous adaptation in which power to heater element 16 is adjusted following receipt of each input sample.

The previously described process continues with each measured temperature sample x(n) received by adaptive controller 20. Thus, the input to transfer function model 26 may be continually adjusted for any perturbations to thermal feedback system 10. When thermal control of laser diode 12 is no longer needed or desired, thermal feedback system 10 may be halted in act 112.

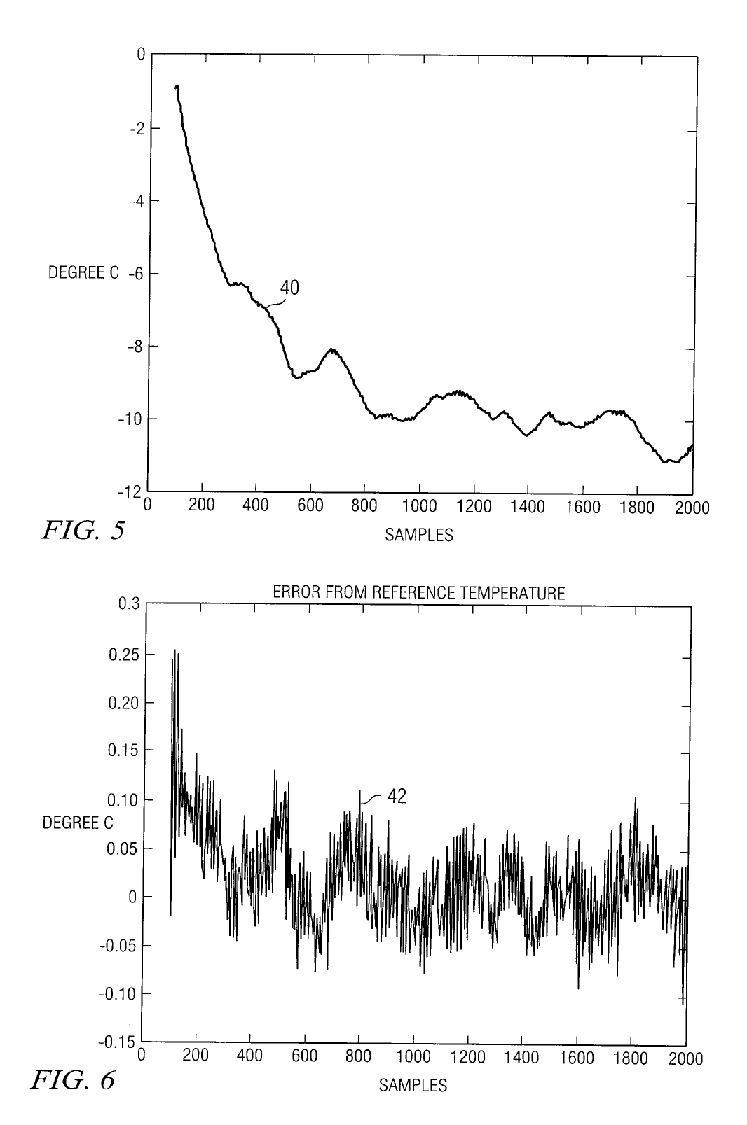

FIGS. 5 and 6 show examples of error plots of a computer simulation that was performed on thermal feedback system 10. In this particular simulation, estimation error eₛₜ(n) includes a modeling error and a laser diode temperature error.

FIG. 5 shows an estimation error eₛₜ(n) plot 40 that may be induced in thermal feedback system 10 as a result of varying noise input v(n) with a random signal. FIG. 6 shows a deviation error (d(n)-y(n)) plot 42. The deviation error may be the deviation of thermal feedback system 10 from temperature reference 22. As can be seen, estimation error eₛₜ(n) may be relatively large in response to relatively rapid changes in noise signal v(n). The temperature of laser diode 12, however, may be controlled within relatively tight limits in spite of relatively rapid variations in estimation error eₛₜ(n) caused by random noise signal v(n).

Although this disclosure has been described in terms of certain embodiments, alterations and permutations of the embodiments will be apparent to those skilled in the art. Accordingly, the above description of the embodiments does not constrain this disclosure. Other changes, substitutions, and alterations are possible without departing from the spirit and scope of this disclosure, as defined by the following claims.

What is claimed is:

1. A thermal feedback system comprising:
a heater element thermally coupled to a device operating at an operating temperature;
a temperature sensor thermally coupled to the device and operable to measure a measured temperature indicative of the operating temperature of the device; and
an adaptive controller coupled to the heater element and the temperature sensor, the adaptive controller operable to:
estimate an estimated error according to the measured temperature and a transfer function model adjusted during calibration;
determine a target from the estimated error and a temperature reference;
adjust, according to the target, an input to the transfer function model to decrease the estimated error; and
adjust power the heater element according to the input.

2. The thermal feedback system of claim 1, wherein the transfer function model comprises an infinite impulse response portion.

3. The thermal feedback system of claim 1, wherein the transfer function model comprises a finite impulse response portion.

4. The thermal feedback system of claim 1, wherein the device comprises a laser diode having a periodically polled lithium niobate (PPLD) material.

5. The thermal feedback system of claim 1, wherein the adaptive controller is operable to:
receive an input calibration signal from an external source; and
recursively adjust the transfer function model in response to changes in the input calibration signal to calibrate the thermal feedback system.

6. The thermal feedback system of claim 1, wherein the adaptive controller performs according to a least mean squares process.

7. The thermal feedback system of claim 1, wherein the adaptive controller comprises an infinite impulse response portion that is implemented as a lattice filter.

8. The thermal feedback system of claim 1, wherein the adaptive controller is operable to adjust, according to the target, the transfer function model by:
adjusting one or more coefficients of the transfer function.

9. A method comprising:
calibrating an adaptive controller having a transfer function model that is coupled to an input of a laser diode;
calculating an estimated error according to an output of the transfer function model and a measured temperature, the measured temperature indicative of an operating temperature of the laser diode;
determining a target from the estimated error and a temperature reference; and
adjusting the input to decrease the estimated error according to the target.

10. The method of claim 9, wherein calibrating the adaptive controller further comprises:
receiving an input calibration signal from an external source; and
recursively adjusting the transfer function model to changes in the input calibration signal to calibrate the thermal feedback system.

11. The method of claim 10, wherein the input calibration signal comprises a random signal combined with a direct current bias.

12. The method of claim 9, wherein the temperature reference is indicative of a temperature in the range of 73 to 105 degrees Celsius.

13. The method of claim 9, wherein the laser diode comprises a periodically polled lithium niobate (PPLD) material.

14. The method of claim 9, wherein the transfer control function comprises a fourth order polynomial function.

15. The method of claim 9, wherein calibrating the adaptive controller further comprises maintaining an ambient temperature at a constant level.

16. The method of claim 9, further comprising applying no electrical power to the input while calibrating the adaptive controller.

17. The method of claim 9, adjusting, according to the target, the transfer function model by:
adjusting one or more coefficients associated with one or more variable to converge the measured temperature with the temperature reference.

18. A thermal feedback system comprising:
a heater element thermally coupled to a laser diode having an input, the laser diode comprising a periodically polled lithium niobate material;
a temperature sensor thermally coupled to the laser diode and operable to measure an operating temperature of the laser diode; and
an adaptive controller comprising a finite impulse response portion and an infinite impulse response portion, the adaptive controller coupled to the heater element and the temperature sensor and operable to:
receive a calibration signal from an external source; and
recursively adjust the transfer function model in response to changes in the calibration signal to calibrate the thermal feedback system;
couple the transfer function model to the input of the laser diode;
calculate an estimated error according to the measured temperature and an output of the transfer function model;
determine a target from the estimated error and a temperature reference; and
adjust the input to decrease the estimated error according to the target.

19. The thermal feedback system of claim 17, wherein the adaptive controller is calibrated according to a least mean squares process.

20. The thermal feedback system of claim 17, wherein the calibration signal comprises a random signal combined with a direct current bias.
